(19) United States
(12) Patent Application Publication
(10) Pub. No.: US 2008/0163126 A1
(43) Pub. Date: Jul. 3, 2008

(54) PRODUCT INSTALLATION USER INTERFACE TREE PRESENTATION

(75) Inventor: Siddhartha Ashok RAO, Sandhausen (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/618,803

(22) Filed: Dec. 30, 2006

(51) Int. Cl. G06F 3/048

(52) U.S. Cl. 715/854

(57) ABSTRACT

A system and method for displaying data involves loading at least one database for each product of a plurality of products each product having a globally unique identifier and a respective product tree which includes a listing of contents. The listing of contents may be displayed and manipulated by a user in a style and manner that the user wishes to see in the user interface for product and/or package selection. The system and method may also involve preparing a respective user interface tree from each respective product tree.

### BACKGROUND

A business system may include a variety of software applications that can be installed on user workstations to allow users to perform operations within the business system. Each software application generally includes an installation application, which when run on a workstation configures the software application on the workstation. Since a business system may include a large number of software applications, many such installations may be required to properly configure a workstation before it can be used in the business system. When a previously-installed software application is to be replaced by an updated version of the application, the previous version often must be removed from the workstation prior to installation of the new version. Software applications are installed on workstations one at a time, each having its own installation instructions.

### BRIEF DESCRIPTION OF THE DRAWINGS

FIG. 1 shows an exemplary embodiment of the present invention.

FIG. 2 shows another exemplary embodiment of the present invention.

FIG. 3 shows another exemplary embodiment of the present invention.

### DETAILED DESCRIPTION

The present invention provides a system and method for supporting multiple software applications on one or more distribution servers. The present invention also provides a system and method for supporting distribution of multiple software applications to workstations, and effecting essentially simultaneous installation, uninstallation, updating, and the like, of those multiple software applications. Such simultaneous installation means that with one action, an administrator or other may effect installation, un-installation, updating, and/or the like, of multiple software applications. A software application may be a software product in its entirety, or part of a software product.

Activities involving application states such as installation, un-installation, updating, and the like, of software applications are stored in an installation database. These activities are represented on product trees viewable by a user.

Software applications, or programs, may be stored in a business system. The software applications may be stored, for example, on an application server in communication with other servers and workstations in the business system. The applications may be stored and accessed using various storage devices and computer systems available. Unless specified otherwise herein, the specific topology of servers, workstations, and communication protocols of the various individual components of the present invention and systems used with the present invention are essentially irrelevant to the present invention, and any such topology and communications as are available may be used with the present invention.

In embodiments of the present invention, each database is split on content basis into a user interface section defining a tree, and an installation data section describing data to be installed. The user interface section of the database is associated with the tree which is displayed to the user. This association is characterized by a product tag. The product tag associates contents with a product. The product tag may serve as the root of the tree. Subsequent components' contents of the product may be associated with successive contains-tags.

The product tag and the contains-tag may include child-tag(s), for example, “requires” tag and/or “excludes” tag. Upon selection of one of these tags, an installation of a component or the exclusion of a component may be forced. The required or excluded component(s) may belong to different products.

A product may be comprised of multiple product databases. Each database, as discussed, contains a user interface section that describes a part of the tree seen on the user interface that belongs to one product. In embodiments of the present invention, one or more databases may be loaded and parsed by a server. Upon reading the user interface section, a user interface node may be created for every node in the product tree. This may occur only for those nodes in the tree which is of type <Product> or <Package> or <Contains>. Those user interface nodes may be linked to create a tree. Further, each node may have one or more properties which are recorded. Such node properties may include name, globally unique identifier, and status identification (e.g., required, excluded). Thus, a tree is formed for each database.

In embodiments of the present invention, a product may be comprised of one or more components. A component, or installation component, may include file(s), registry key(s), script, etc. An action can install a component. A user interface layer, for example, may be a collection of actions. Installation and uninstallation of a product or a product component affects the resulting tree formed.

In embodiments of the present invention, every product is identified by a globally unique identifier. The trees belonging to the same product are identified using the globally unique identifier. The trees may be assimilated, thus, making one tree out of multiple databases per product. This can be done for every product, and a composite multi-products tree may be formed. When the tree is displayed and modified, the tree may be refreshed to display any updates concerning required and/or excluded nodes, regardless of whether the nodes belong to different products or the same product. Thus, a listing of contents may be displayed and manipulated by a user in a style and manner that the user wishes to see in the user interface for product and/or package selection.

In embodiments of the present invention, a system and method for displaying data is provided and involves loading at least one database for each product of a plurality of products, each product having a globally unique identifier and a respective product tree which includes a listing of contents. The listing of contents may be displayed and manipulated by a user in a style and manner that the user wishes to see in the user interface for product and/or package selection. The system and method may also involve preparing a respective user interface tree from each respective product tree. This may involve creating a user interface node for each node of a certain type content in the listing of contents; linking each of the user interface nodes, wherein each user interface node is associated with a node property; identifying all respective user interface trees associated with the respective globally unique identifier of the respective product; linking all respective user interface trees associated with the same globally unique identifier of the respective product forming one product tree for each respective product; linking each product tree associated with the plurality of products to form a multi-products tree; and displaying the multi-products tree.

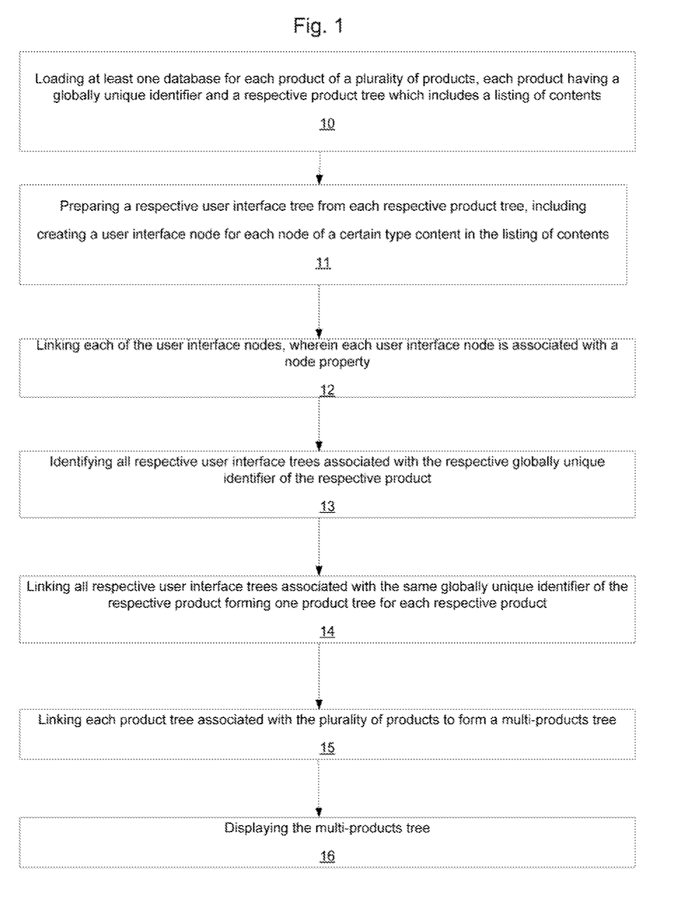

FIG. 1 shows a system and method of providing a mechanism for displaying and manipulating a listing of contents by a user for display in a user interface involving loading at least one database for each product of a plurality of products, each product having a globally unique identifier and a respective product tree which includes a listing of contents 10. The method further involves preparing a respective user interface tree from each respective product tree. A user interface node is created for each node of a certain type content—which may be fixed before use by a user, software administrator, software manufacturer, or other—in the listing of contents 11. Each of the user interface nodes are linked 12. Each user interface node is associated with a node property. All respective user interface trees associated with the respective globally unique identifier of the respective product are identified 13. All respective user interface trees associated with the same globally unique identifier of the respective product forming one product tree for each respective product are identified 14. Each product tree associated with the plurality of products are linked to form a multi-products tree 15. The resulting multi-product tree is then viewable. Embodiments of the present invention provide a user the ability to see and/or display a product or multi-products in a pre-specified and/or dynamically specified way.

In embodiments of the present invention, each user interface node is identifiable by a name and a globally unique identifier. Further, each user interface node may have one or more node properties such as a status identification. The status identification indicates whether the respective node is one of selected, deselected, and unselected. Thus, if the status identification indicates the respective node is selected, then this effects a selection of any nodes required by the respective node, and a deselection of any nodes excluded by the respective node. If the status identification indicates that the respective node is deselected, then this effects a deselection of any nodes required by the respective node. If the status identification indicates that the respective node is unselected, then no action occurs upon the respective node, any required nodes of the respective node, and any excluded nodes of the respective node. For example, in a two-node system, if node A requires node B, then the selection by a user of node A automatically selects node B. Likewise, if node A excludes node B (i.e., node A cannot be in the same system as node B), then the selection of node A automatically deselects node B.

In further embodiments, a certain type contents may be a product type, a package type, and/or a contains type.

In further embodiments, a user may change the status identification of a node, and an updated multi-products tree may be displayed. And, the changing of the status identification of a node may result in a changing of the status identification of another node. These nodes may be associated with different products or parts thereof.

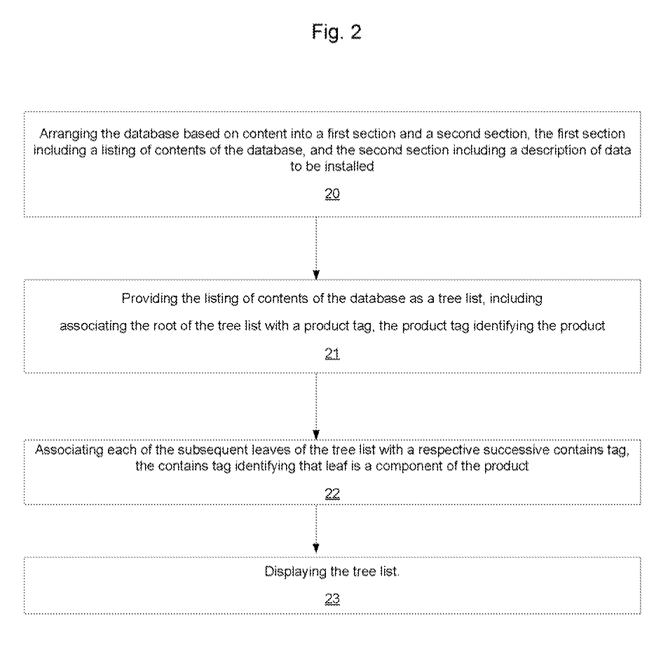

FIG. 2 shows an exemplary method of preparing a database associated with a product for display is provided. The database is arranged based on content into a first section and a second section 20. The first section may include a listing of contents of the database, and the second section may include a description of data to be installed. The listing of contents of the database is then provided as a tree list. In this embodiments of the present invention, the listing of contents thus, may be displayed and manipulated by a user in a style and manner that the user wishes to see in the user interface for product and/or package selection.

Specifically, the root of the tree list is associated with a product tag which identifies a product 21. Each of the subsequent leaves of the tree list is associated with a respective successive contains tag 22. The contains tag identifies that the leaf is a component of the product. The resulting tree list is then displayable 23. The product tag and/or the contains tag may include at least one of a requires tag and an excludes tag. The requires tag indicates that the associated component of the product should be installed. The excludes tag indicates that the associated component of the product should be uninstalled.

In further embodiments, an initiation of installing the associated component having the requires tag upon changing to the requires tag and/or uninstalling the associated component having the excludes tag upon changing to the excludes tag is effected by a user, administrator, or other.

In further embodiments, the changing of at least one of the requires tag and the excludes tag of an associated component of the product automatically causes a changing of at least one of the requires tag and the excludes tag of another component of the product.

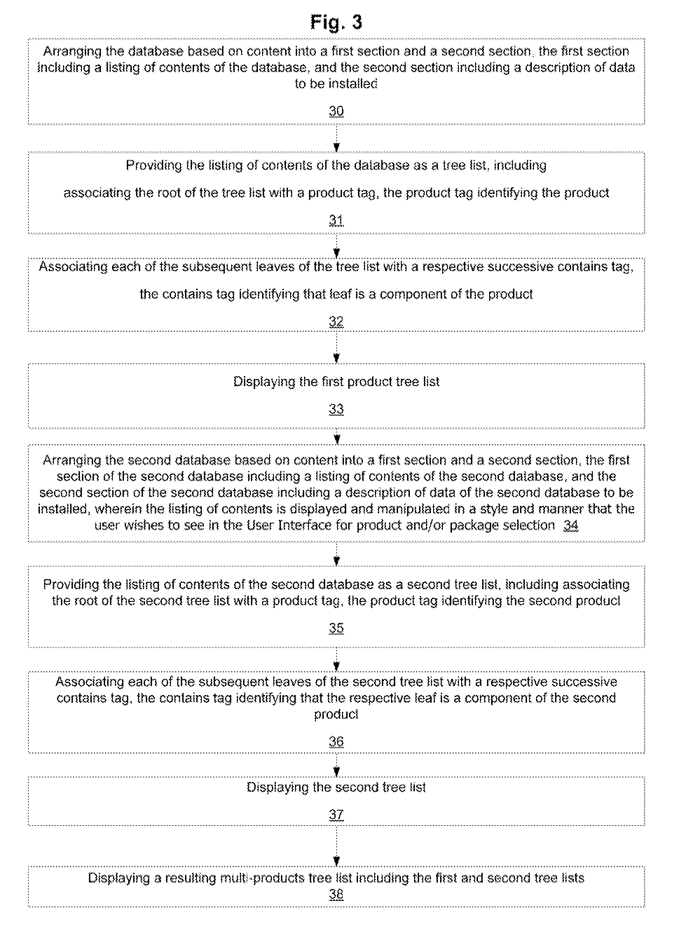

FIG. 3 shows an exemplary method and system of preparing a database associated with a product for display. A database is arranged based on content into a first section and a second section, the first section including a listing of contents of the database, and the second section including a description of data to be installed 30.

The listing of contents of the database as a tree list, including associating the root of the tree list with a product tag, the product tag identifying the product 31. Each of the subsequent leaves of the tree list is associated with a respective successive contains tag 32. The contains tag identifying that leaf is a component of the product. The tree list may be displayed in a manner such that the construction of the tree list provides that the contents of the tree list are displayable to a user 33.

At least one second database for display associated with at least a second product is provided. The second database is arranged based on content into a first section and a second section 34. The first section of the second database includes a listing of contents of the second database. The second section of the second database includes a description of data of the second database to be installed. Thus, the listing of contents may be displayed and manipulated by a user in a style and manner that the user wishes to see in the user interface for product and/or package selection.

The listing of contents of the second database is provided as a second tree list. The root of the second tree list is associated with a product tag 35. The product tag identifies the second product. Each of the subsequent leaves of the second tree list is associated with a respective successive contains tag 36. The contains tag identifies that the respective leaf is a component of the second product. The resulting second tree list may be displayed 37. Further, at least one of installing the associated component having the requires tag upon changing to the requires tag and uninstalling the associated component having the excludes tag upon changing to the excludes tag may be initiated. The changing of at least one of the requires tag and the excludes tag of an associated component of the first product may automatically cause a changing of the requires tag and/or the excludes tag of the associated component of the second product.

In further embodiments, the product tag and/or the contains tag associated with the second tree list may include at least one of a requires tag and an excludes tag. The requires tag may indicate that the associated component of the second product should be installed. The excludes tag may indicate that the associated component of the second product should be uninstalled.

In further embodiments, the tree list may be constructed in a way that the contents are viewable by a user or another.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method of displaying data, comprising:
loading at least one database for each product of a plurality of products, each product having a globally unique identifier and a respective product tree which includes a listing of contents;
preparing a respective user interface tree from each respective product tree, including:
creating a user interface node for each node of a certain type content in the listing of contents;
linking each of the user interface nodes, wherein each user interface node is associated with a node property;
identifying all respective user interface trees associated with the respective globally unique identifier of the respective product;
linking all respective user interface trees associated with the same globally unique identifier of the respective product forming one product tree for each respective product;
linking each product tree associated with the plurality of products to form a multi-products tree; and
displaying the multi-products tree.

2. The method of claim 1, wherein each user interface node is associated with a name.

3. The method of claim 1, wherein the node property is a status identification.

4. The method of claim 3, wherein the certain type content is fixed before use by a user.

5. The method of claim 4, wherein the certain type content is fixed by one of a software administrator and a software manufacturer.

6. The method of claim 4, wherein the certain type content is at least one of a product type, a package type, and a contains type.

7. The method of claim 4, wherein the status identification indicates whether the respective node is one of selected, deselected, and unselected.

8. The method of claim 7, further comprising:
if the status identification indicates the respective node is selected, then effecting a selection of any nodes required by the respective node, and a deselection of any nodes excluded by the respective node;
if the status identification indicates that the respective node is deselected, then effecting a deselection of any nodes required by the respective node; and
if the status identification indicates that the respective node is unselected, then effecting no action upon the respective node, any required nodes of the respective node, and any excluded nodes of the respective node.

9. The method of claim 7, further comprising:
changing the status identification by a user; and
displaying a resulting updated multi-products tree.

10. The method of claim 9, wherein the changing of the status identification of the node is effected automatically as a result of changing the status identification of another node.

11. The method of claim 9, wherein the node and the another node are associated with different products.

12. The method of claim 1, further comprising using at least one visual tool to create a software package installation, wherein the user provides a specification of the user interface tree desired and the at least one visual tool constructs a database in accordance with the specification and compliant with any installation tools.

13. A method of preparing a database associated with a product for display, comprising:
arranging the database based on content into a first section and a second section, the first section including a listing of contents of the database, and the second section including a description of data to be installed;
providing the listing of contents of the database as a tree list, including:
associating the root of the tree list with a product tag, the product tag identifying the product,
associating each of the subsequent leaves of the tree list with a respective successive contains tag, the contains tag identifying that leaf is a component of the product; and
displaying the tree list.

14. The method of claim 13, wherein the tree list is constructed in a way the contents should be viewed by a user.

15. The method of claim 14, wherein at least one of the product tag and the contains tag includes at least one of a requires tag and an excludes tag, the requires tag indicating that the associated component of the product should be installed, the excludes tag indicating that the associated component of the product should be uninstalled.

16. The method of claim 15, further comprising initiating at least one of installing the associated component having the requires tag upon changing to the requires tag and uninstalling the associated component having the excludes tag upon changing to the excludes tag.

17. The method of claim 16, wherein the changing of at least one of the requires tag and the excludes tag of an associated component of the product automatically causes a changing of at least one of the requires tag and the excludes tag of another component of the product.

18. The method of claim 16, further comprising preparing a second database for display associated with a second product, including:
arranging the second database based on content into a first section and a second section, the first section of the second database including a listing of contents of the second database, and the second section of the second database including a description of data of the second database to be installed;
providing the listing of contents of the second database as a second tree list, including:
associating the root of the second tree list with a product tag, the product tag identifying the second product,
associating each of the subsequent leaves of the second tree list with a respective successive contains tag, the contains tag identifying that the respective leaf is a component of the second product; and
displaying the second tree list.

19. The method of claim 18, wherein at least one of the product tag and the contains tag associated with the second tree list includes at least one of a requires tag and an excludes tag, the requires tag indicating that the associated component of the second product should be installed, the excludes tag indicating that the associated component of the second product should be uninstalled; and,
further comprising initiating at least one of installing the associated component having the requires tag upon changing to the requires tag and uninstalling the associated component having the excludes tag upon changing to the excludes tag, wherein the changing of at least one of the requires tag and the excludes tag of an associated component of the first product automatically causes a changing of at least one of the requires tag and the excludes tag of the associated component of the second product.

20. A system for automatic creation of an installation database, comprising:
at least one visual tool, the visual toot participating in creating an installation setup;
a user interface tree provided by the user,
wherein the visual tool constructs a database in accordance with the user interface tree provided by the user, including:
arranging the database based on content into a first section and a second section, the first section including a listing of contents of the database, and the second section including a description of data to be installed;
providing the listing of contents of the database as a tree list, including:
associating the root of the tree list with a product tag, the product tag identifying the product,
associating each of the subsequent leaves of the tree list with a respective successive contains tag, the contains tag identifying that leaf is a component of the product; and
displaying the tree list.
